(19) United States
(12) Patent Application Publication
(10) Pub. No.: US 2007/0081663 A1
(43) Pub. Date: Apr. 12, 2007

(54) Time scale modification of audio based on power-complementary IIR filter decomposition

(76) Inventors: Atsuhiro Sakurai, Tsukuba-shi (JP); Steven Trautmann, Tsukuba (JP); Daniel L. Zelazo, Seattle, WA (US)

Correspondence Address: TEXAS INSTRUMENTS INCORPORATED, P O BOX 655474, M/S 3999, DALLAS, TX, 75265, US

(21) Appl. No.: 11/248,078

(22) Filed: Oct. 12, 2005

(51) Int. Cl. H04M 1/00

(52) U.S. Cl. 379/390.02

(57) ABSTRACT

This invention involves time-scale modification of audio signals. In this invention the input audio signal is separated into two frequency bands using a complementary IIR filter bank. Time-scale modification is applied separately to the individual frequency bands. The thus modified signals are recombined for output.

### TECHNICAL FIELD OF THE INVENTION

The technical field of this invention is digital audio time scale modification.

### BACKGROUND OF THE INVENTION

Time-scale modification (TSM) is an emerging topic in audio digital signal processing due to the advance of low-cost, high-speed hardware that enables real-time processing by portable devices. Possible applications include intelligible sound in fast-forward play, real-time music manipulation, foreign language training, etc. Most time scale modification algorithms can be classified as either frequency-domain time scale modification or time-domain time scale modification. Frequency-domain time scale modification provides higher quality for polyphonic sounds, while time-domain time scale modification is more suitable for narrow-band signals such as voice. Time-domain time scale modification is the natural choice in resource-limited applications due to its lower computational cost.

The basic operation of time domain time-scale modification is successively overlapping and adding audio frames, where time scaling is achieved by changing the spacing between them. It is known in the art to calculate the exact overlap point based on a measure of similarity between the signals to be overlapped. This measure of similarity is generally based on cross-correlation.

Most time-domain time-scale modification algorithms are derived from the synchronous overlap-and-add method (SOLA). The synchronous overlap-and-add algorithm and its variations are based on successive overlap and addition of audio frames. For the overlap, the overlap point is adjusted by computing a measure of signal similarity between the overlapping regions for each possible overlap position, which is limited by a minimum and maximum overlap points. The position of maximum similarity is selected. The signal similarity measure can be represented as a full cross-correlation function or simplified versions. This similarity calculation represents about 80% or more of the total computation required by the algorithm.

Even though SOLA based methods represent an attractive low-cost solution to the time-scale modification problem, their limitation stands out in the case of polyphonic music signals. Their intrinsic problem is that the audio signal is treated as a whole without consideration for its individual frequency components, so that the overlap point adjustment based on signal similarity cannot simultaneously generate smooth transitions for the multiple frequency components of the signal.

A family of methods known as phase vocoder does time-scale modification in the frequency domain. The input signal is analyzed at equally spaced overlapping windowed frames using a short-time discrete Fourier transform. Next the phase difference for spectral peaks is calculated. This phase difference is the difference in phase between an input phase and a time scale modified signal phase. An intrinsic sinusoidal model is generally used. The frequency is represented by the sum Ωₖ+ωᵢₖ: where carrier Ωₖ is 2Πk/N; and ωᵢₖ is an instantaneous frequency modulator. This produces an estimate ωᵢₖ for each spectral line by obtaining the phase difference between two consecutive analysis frames. Here, k is the spectral line and N is the size of the short-time discrete Fourier transform. The process reconstructs an output signal from the analyzed frames using a short-time inverse discrete Fourier transform. The frames are overlapped by a different overlap factor to achieve the desired time scaling. The instantaneous frequency ωᵢₖ is used to calculate the phase corresponding to each spectral line in the time shifted instant.

Even though phase vocoders can potentially achieve higher quality than time-domain methods, a severe limitation is the large amount of computation required in the forward and inverse discrete Fourier transforms and also in the spectrum manipulation process. Practical implementations on fixed-point processors result in a computational cost up to 10 times higher than time-domain time-scale modification methods. In addition, maintaining phase coherence between frames is not an easy task and can be the source of artifacts.

### SUMMARY OF THE INVENTION

This invention involves time-scale modification of audio signals. In this invention the input audio signal is separated into two frequency bands via an IIR filter bank. Time-scale modification is applied separately to the individual frequency bands. The thus modified signals are recombined for output.

### BRIEF DESCRIPTION OF THE DRAWINGS

These and other aspects of this invention are illustrated in the drawings, in which:

FIG. 1 is a block diagram of a digital audio system to which this invention is applicable;

FIG. 2 is a flow chart illustrating the data processing operations involved in time-scale modification employing the digital audio system of FIG. 1;

FIG. 3a illustrates the analysis step in the overlap and add method of time scale modification according to the prior art;

FIG. 3b illustrates the synthesis step in the overlap and add method of time-scale modification according to the prior art;

FIG. 4a illustrates the analysis step in synchronous overlap and add method of time scale modification according to the prior art;

FIG. 4b illustrates the synthesis step in the synchronous overlap and add method of time-scale modification according to the prior art;

FIG. 5 is a flow chart illustrating the steps in the prior art phase vocoder time scale modification technique;

FIG. 6 is a view of several waveforms used in explanation of this invention; and

FIG. 7 is a process diagram illustrating the processes of this invention.

### DETAILED DESCRIPTION OF PREFERRED EMBODIMENTS

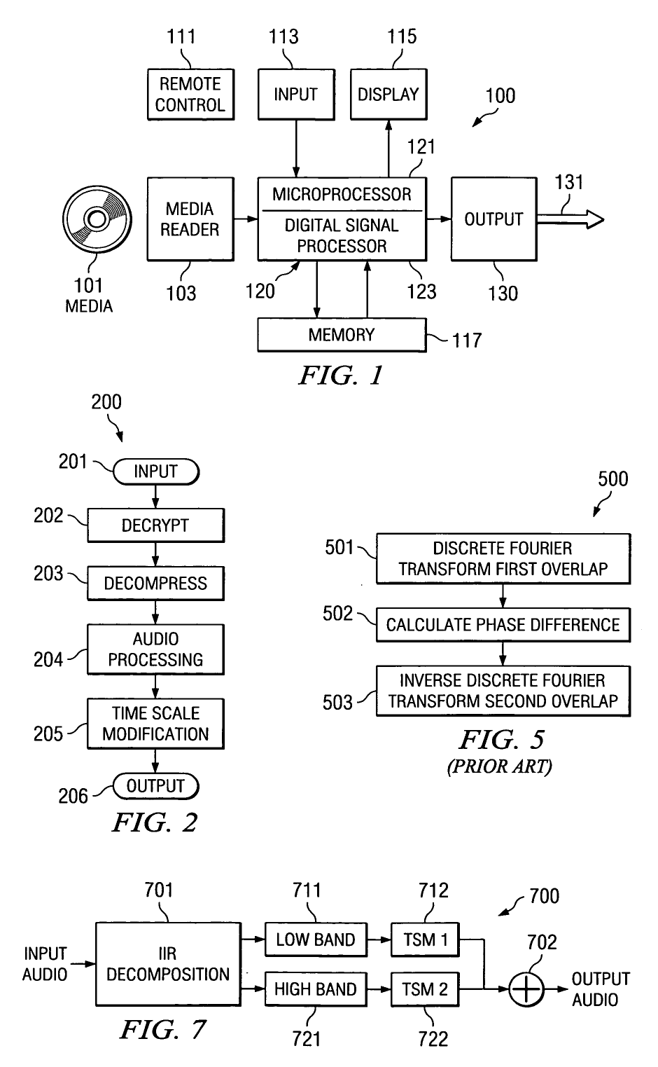

FIG. 1 is a block diagram illustrating a system to which this invention is applicable. The preferred embodiment is a DVD player or DVD player/recorder in which the time scale modification of this invention is employed with fast forward or slow motion video to provide audio synchronized with the video in these modes.

System 100 received digital audio data on media 101 via media reader 103. In the preferred embodiment media 101 is a DVD optical disk and media reader 103 is the corresponding disk reader. It is feasible to apply this technique to other media and corresponding reader such as audio CDs, removable magnetic disks (i.e. floppy disk), memory cards or similar devices. Media reader 103 delivers digital data corresponding to the desired audio to processor 120.

Processor 120 performs data processing operations required of system 100 including the time scale modification of this invention. Processor 120 may include two different processors, microprocessor 121 and digital signal processor 123. Microprocessor 121 is preferably employed for control functions such as data movement, responding to user input and generating user output. Digital signal processor 123 is preferably employed in data filtering and manipulation functions such as the time scale modification of this invention. A Texas Instruments digital signal processor from the TMS320C5000 family is suitable for this invention.

Processor 120 is connected to several peripheral devices. Processor 120 receives user inputs via input device 113. Input device 113 can be a keypad device, a set of push buttons or a receiver for input signals from remote control 111. Input device 113 receives user inputs which control the operation of system 100. Processor 120 produces outputs via display 115. Display 115 may be a set of LCD (liquid crystal display) or LED (light emitting diode) indicators or an LCD display screen. Display 115 provides user feedback regarding the current operating condition of system 100 and may also be used to produce prompts for operator inputs. As an alternative for the case where system 100 is a DVD player or player/recorder connectable to a video display, system 100 may generate a display output using the attached video display. Memory 117 preferably stores programs for control of microprocessor 121 and digital signal processor 123, constants needed during operation and intermediate data being. manipulated. Memory 117 can take many forms such as read only memory, volatile read/write memory, nonvolatile read/write memory or magnetic memory such as fixed or removable disks. Output 130 produces an output 131 of system 100. In the case of a DVD player or player/recorder, this output would be in the form of an audio/video signal such as a composite video signal, separate audio signals and video component signals and the like.

FIG. 2 is a flow chart illustrating process 200 including the major processing functions of system 100. Flow chart 200 begins with data input at input block 201. Data processing begins with an optional decryption function (block 202) to decode encrypted data delivered from media 101. Data encryption would typically be used for control of copying for theatrical movies delivered on DVD, for example. System 100 in conjunction with the data on media 101 determines if this is an authorized use and permits decryption if the use is authorized.

The next step is optional decompression (block 203). Data is often delivered in a compressed format to save memory space and transmit bandwidth. There are several motion picture data compression techniques proposed by the Motion Picture Experts Group (MPEG). These video compression standards typically include audio compression standards such as MPEG Layer 3 commonly known as MP3. There are other audio compression standards. The result of decompression for the purposes of this invention is a sampled data signal corresponding to the desired audio. Audio CDs typically directly store the sampled audio data and thus require no decompression.

The next step is audio processing (block 204). System 100 will typically include audio data processing other than the time scale modification of this invention. This might include band equalization filtering, conversion between the various surround sound formats and the like. This other audio processing is not relevant to this invention and will not be discussed further.

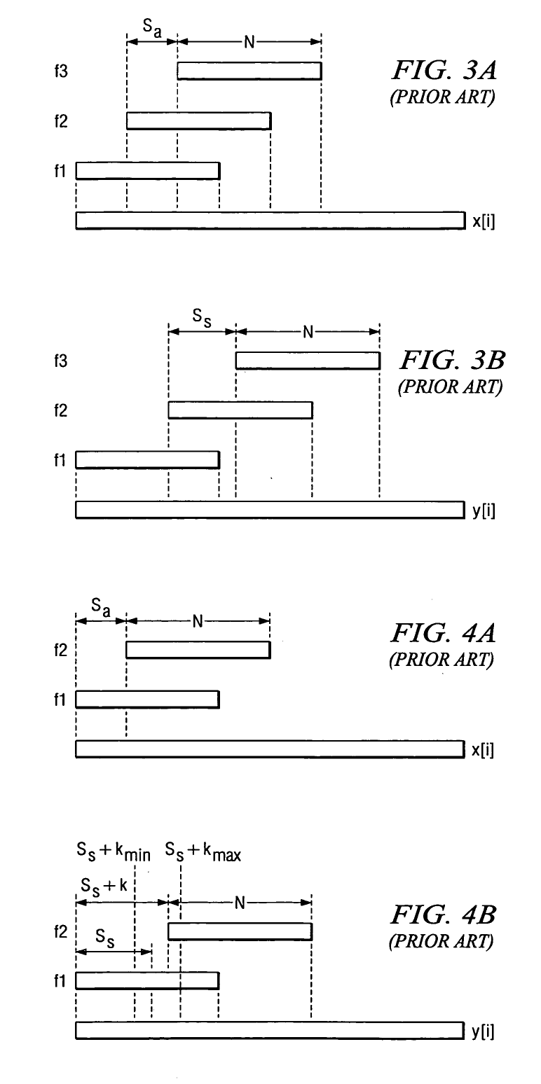

The next step is time scale modification (block 205). This time scale modification is the subject of this invention and various techniques of the prior art and of this invention will be described below in conjunction with FIGS. 3 to 6. Flow chart 200 ends with data output (block 206).

FIG. 3 illustrates this process. In FIG. 3(a), x(i) is the analysis signals represented as a sequence with index i. Similarly, FIG. 3(b) illustrates synthesis signal y(i) having a sequence index i. The quantity N is the frame size. Sₐ is the analysis frame interval between consecutive frames fⱼ (where j=1, 2 . . . ). Sₛ is the similar synthesis frame interval. The relationship between the analysis frame interval Sₐ and the synthesis frame interval Sₛ sets the time scale modification. The overlap-and-add time scale modification algorithm is simple and provides acceptable results for small time-scale factors. In general this method yields poor quality compared to other methods described below.

The synchronous overlap-and-add time scale modification algorithm is an improvement over the previous overlap-and-add approach. Instead of using a fixed overlap interval for synthesis, the overlap point is adjusted by computing the normalized cross-correlation between the overlapping regions for each possible overlap position within minimum and maximum deviation values. The overlap position of maximum cross-correlation is selected. The cross-correlation is calculated using the following formula, where Lₖ is the length of the overlapping window:

$$R [ k ] = \frac{{\sum }_{i = 0}^{{L}_{k} - 1} y [ {mS}_{s} + k + i ] x [ {mS}_{a} + i ]}{{[ {\sum }_{i = 0}^{{L}_{k} - 1} {y}^{2} [ {mS}_{s} + k + i ] {\sum }_{i = 0}^{{L}_{k} - 1} {x}^{2} [ {mS}_{a} + i ] ]}^{1 / 2}} \qquad ( 1 )$$

FIG. 4 illustrates the synchronous overlap-and-add time scale modification algorithm. The same variables are used in FIG. 4(a) for analysis as FIG. 3(a) and used in FIG. 4(b) for synthesis as in 3 (b). In FIG. 4, k is the deviation of the overlap position, with k limited to the range between kₘᵢₙ and kₘₐₓ. Note that k=0 is equivalent to the overlap-and-add time scale modification algorithm illustrated in FIGS. 3(a) and 3(b). The synchronous overlap-and-add time scale modification algorithm requires a large amount of computation to calculate the normalized cross-correlation used in equation 1. The similarity computation can be reduced using a more efficient normalized cross-correlation formula or another measure of signal similarity instead of equation 1. Even such a reduced computation will still be the most computation-expensive part of the algorithm. The following discussion applies to whatever normalized cross-correlation formula or measure of signal similarity is used. This computation enables better phase matching for each overlapping frame, thus improving the resulting sound quality.

FIG. 5 is a flow chart illustrating process 500 including the basic phase vocoder as known in the art. At block 501 the input signal is analyzed at equally spaced overlapping windowed frames using a short-time discrete Fourier transform. The resulting data describes short time intervals of the audio data in the frequency domain. Next the phase difference for spectral peaks is calculated (block 502). This phase difference is the difference in phase between an input phase and a time scale modified signal phase. Block 502 uses an intrinsic sinusoidal model where the frequency is represented by the sum Ω_{k+ω}ᵢₖ: where carrier Ωₖ is 2Πk/N; and ωᵢₖ is an instantaneous frequency modulator. Block 502 estimates ωᵢₖ for each spectral line by obtaining the phase difference between two consecutive analysis frames. Here, k is the spectral line and N is the size of the short-time discrete Fourier transform.

Process 500 reconstructs an output signal from the analyzed frames using a short-time inverse discrete Fourier transform (block 503). The frames are overlapped by a different overlap factor to achieve the desired time scaling. The instantaneous frequency ωᵢₖ is used to calculate the phase corresponding to each spectral line in the time shifted instant.

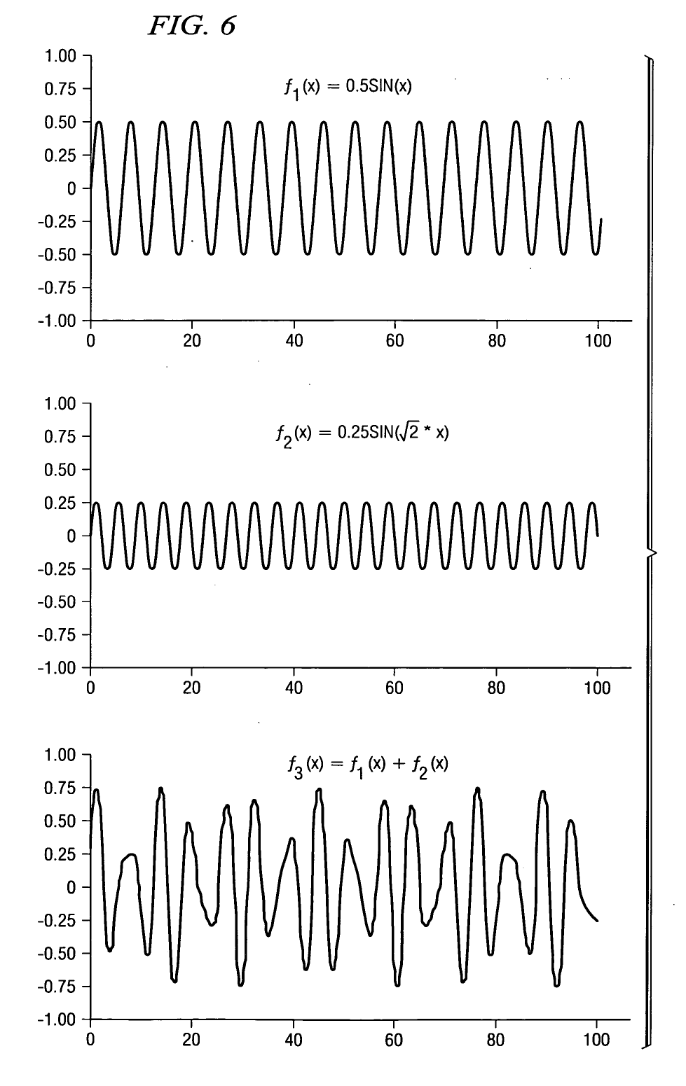

Consider a simple signal consisting of non-harmonically related frequencies, such as f₁=0.5sin(x) and f₂=0.25sin(\sqrt{2}x) and their sum f₃ illustrated in FIG. 6. Because the signals f₁ and f₂ are not harmonically related, any instantaneous relationship between their respective phases will never be repeated exactly because a perfect match would require an integer number of periods of both signals. Thus a time-domain time-scale modification technique would try to find a close match within signal f₃ but there will always be some phase disruption when jumping to a different location. This phase match problem causes artifacts for many time-domain time-scale modification techniques. Now consider separating these components and performing a similar operation on each signal individually. In this case, there is little problem finding a perfect phase match for each signal, though it will be at different locations. Combining the resulting time-scaled signals produces an artifact-free time-scaled whole. Unfortunately in the real world, even narrow band signals do not repeat perfectly due to changes in pitch and amplitude, and to interference among close frequencies. However analysis in separate frequency bands gives each band great flexibility in finding the best overlap point. This improves overall quality.

One of the limitations of the prior art in terms of computational cost and complexity is the use of high-order FIR filters, along with the existence of up to a large number of non-decimated frequency bands.

In the present invention these problems are resolved by using IIR (Infinite Impulse Response) filters instead of FIR filters, and by reducing the number of bands to 2. These enhancements are sufficient to make the invention considerably less computationally intensive than frequency-domain methods, while keeping the output quality higher than conventional time-domain methods.

The use of IIR filters is made possible by introducing the concept of complementary transfer functions-. Namely, if a Butterworth, Chebyshev, or elliptic low-pass filter H₀(z) has order N (where N is odd and the filter has real-valued symmetric coefficients), it is possible to decompose it into two all-pass functions A₀(z) and A₁(z). These all-pass functions can be recombined as

$${H}_{0} ( z ) = \frac{{A}_{0} ( z ) + {A}_{1} ( z )}{2} \qquad ( 1 )$$

to form the original low-pass filter, or as

$${H}_{1} ( z ) = \frac{{A}_{0} ( z ) - {A}_{1} ( z )}{2} \qquad ( 2 )$$

to form a complementary high-pass filter. In this case, it can be shown that H₀(z) and H₁(z) satisfy
|H₀(e^{jω})|²+|H₁(e^{jω})|²=const (3)
for all frequencies ω, i.e., H₀(z) and H₁(z) are power-complementary. Thus, the filter pair (H₀, H₁) can be used to efficiently separate the audio signal into low and -high frequency bands without introducing significant distortions when the bands are recombined by addition. The decomposition above also shows that it is possible to implement the pair of filters (H₀, H₁) with the cost of just one filter.

One embodiment of the invention was implemented using a 3rd-order Butterworth low-pass filter as the prototype filter H₀(z). The prototype filter was designed using the following design specifications:

TABLE 1
Design characteristics of the prototype Butterworth low-pass filter

| | | |
|---|---|---|
| Band-stop frequency | 1000 | Hz |
| Band-pass frequency | 3000 | Hz |
| Max. attenuation in pass-band | 1 | dB |
| Min. attenuation in stop-band | 20 | dB |

FIG. 7 illustrates the filter bank time-scale modification method of this invention. Analysis filter bank 701 receives the input audio and generates 2 band limited signals in 2 respective frequency bands. Analysis filter bank 701 can be one or more infinite impulse response (IIR) filters. These are preferably designed so that the bands could be simply summed in synthesis filter bank 702 to perfectly reconstruct the original signal. Both frequency bands may be further processed (In band blocks 711 and 721). Next both frequency bands are subject to time-domain time-scale modification via the corresponding TSM unit 712 and 722. Computation block 702 recombines the outputs by simple addition.

Listening tests indicated that the quality achieved by the above embodiment is clearly higher than conventional time-domain methods, with a computational cost significantly lower than frequency-domain methods. In the case of speech signals, the quality compares favorably even with frequency domain methods because of the non-existence of any artifacts derived from phase inconsistency between bands, a problem commonly faced by frequency-domain methods.

The filter bank time-scale modification technique of this invention is a fundamental approach that can be applied in many ways. Some but not all of these ways produce excellent results. There are no pre-defined constraints on the filter bank used nor on the time-scale modification method used within each frequency band. There is no requirement that only time-domain time-scale modification techniques be applied to individual bands. Frequency domain time-scale modification or other techniques could also be applied. There can be some relationship between the time-scale modification methods between bands. Different time-scale modification techniques may be applied to different bands. To apply filter bank time-scale modification in a useful way, various design issues must be considered such as the computational resource available and desired level of quality. Psychoacoustic principles will control which implementations are successful and which are not.

What is claimed is:

1. A method of time-scale modification of a digital audio signal comprising the steps of:
separating the digital audio signal into two frequency bands using IIR filters;
separately time-scale modifying each of the two frequency bands producing corresponding time-scale modified frequency band signals; and
combining the separate time-scale modified frequency band signals.

2. The method of claim 1, wherein:
said step of separately time-scale modifying each of the plurality of frequency bands includes time-domain time-scale modification.

3. The method of claim 2, wherein:
said step of time-domain time-scale modification of each frequency band includes
analyzing each frequency band in a set of first equally spaced, overlapping time windows having a first overlap amount Sₐ,
selecting a base overlap Sₛ for output synthesis corresponding to a desired time scale modification,
calculating a measure of similarity between overlapping frames of each frequency band for a range of overlaps between Sₛ+kₘᵢₙ to Sₛ+kₘₐₓ of the single audio signal, where kₘᵢₙ is a minimum overlap deviation and kₘₐₓ is a maximum overlap deviation,
determining an overlap deviation k yielding the largest measure of similarity for each frequency band,
synthesizing an output signal for each frequency band in a set of second equally spaced, overlapping time windows having a second overlap amount equal to Sₛ+k.

4. The method of claim 1, wherein:
said step of separately time-scale modifying each of the plurality of frequency bands includes frequency-domain time-scale modification.

5. The method of claim 4, wherein:
said step of frequency-domain time-scale modification of each frequency band includes
analyzing each frequency band at equally spaced overlapping windowed frames using a short-time discrete Fourier transform,
calculating a phase difference between an input phase and a time scale modified signal phase for each frequency band, and
reconstructing an output signal for each frequency band from the analyzed frames using a short-time inverse discrete Fourier transform employing the corresponding calculated phase difference.

6. The method of claim 1, wherein:
the digital audio signal consists of an MPEG Layer 3 compressed audio signal; and
said step of separating the digital audio signal into a plurality of frequency bands includes
decoding the MPEG Layer 3 compressed audio signal into a plurality of decimated subbands, and
employing the decimated subbands as the plurality of frequency bands.

7. A digital audio apparatus comprising:
a source of a digital audio signal;
a digital signal processor connected to said source of a digital audio signal programmed to perform time scale modification on the digital audio signal by
separating the digital audio signal into two frequency bands using IIR filters,
separately time-scale modify each of the frequency bands producing corresponding time-scale modified frequency band signals,
combining the separate time-scale modified frequency band signals; and
an output device connected to the digital signal processor for outputting the time scale modified digital audio signal.

8. The digital audio apparatus of claim 7, wherein:
said digital signal processor is programmed to separately time-scale modify each of the frequency bands by time-domain time-scale modification.

9. The digital audio apparatus of claim 8, wherein:
said digital signal processor is programmed to time-domain time-scale modify each frequency band by
analyzing each frequency band in a set of first equally spaced, overlapping time windows having a first overlap amount Sₐ,
selecting a base overlap Sₛ for output synthesis corresponding to a desired time scale modification,
calculating a measure of similarity between overlapping frames of each frequency band for a range of overlaps between Sₛ+kₘᵢₙ to Sₛ+kₘₐₓ of the single audio signal, where kₘᵢₙ is a minimum overlap deviation and kₘₐₓ is a maximum overlap deviation,
determining an overlap deviation k yielding the largest measure of similarity for each frequency band,
synthesizing an output signal for each frequency band in a set of second equally spaced, overlapping time windows having a second overlap amount equal to Sₛ+k.

10. The digital audio apparatus of claim 7, wherein:
said digital signal processor is programmed to separately time-scale modify each of the plurality of frequency bands by frequency-domain time-scale modification.

11. The digital audio apparatus of claim 10, wherein:
said digital signal processor is programmed to frequency-domain time-scale modify the plurality of frequency bands by
analyzing each frequency band at equally spaced overlapping windowed frames using a short-time discrete Fourier transform,
calculating a phase difference between an input phase and a time scale modified signal phase for each frequency band, and
reconstructing an output signal for each frequency band from the analyzed frames using a short-time inverse discrete Fourier transform employing the corresponding calculated phase difference.

12. The digital audio apparatus of claim 7, wherein:
said source of a digital audio signal produces an MPEG Layer 3 compressed audio signal; and
said digital signal processor is programmed to
decode said MPEG Layer 3 compressed audio signal into a plurality of decimated subbands, and
employ the decimated subbands as the plurality of frequency bands.
